(19) United States
(12) Patent Application Publication
(10) Pub. No.: US 2001/0032417 A1
(43) Pub. Date: Oct. 25, 2001

(54) Sealing door for a rail car

(76) Inventors: Paul Degelman, Regina (CA); Justin Tremblay, Regina (CA)

Correspondence Address: ADE & COMPANY, 1700-360 MAIN STREET, WINNIPEG, MB, R3C3Z3, CA

(21) Appl. No.: 09/828,580

(22) Filed: Apr. 9, 2001

(30) Foreign Application Priority Data
Apr. 7, 2000 (CA) 2,304,922
Sep. 15, 2000 (CA) 2,319,923

(51) Int. Cl. E05D 15/10; E05D 13/00

(52) U.S. Cl. 49/214; 49/213; 49/409

(57) ABSTRACT

A sliding door arrangement for use on a box car, the box car having a main body and an opening on one side of the body. The sliding door arrangement comprises a rail system on the body at the opening, the rail system has a top rail and a bottom rail horizontally orientated and located at a top side and a bottom side respectively of the opening, a housing defining the door which is arranged to close upon the opening, a rail assembly coupled to the housing and connected to the rail system at a top side and a bottom side of the housing respectively such that the housing is slidably moved in a generally horizontal direction on the rail system for opening and closing the opening, a rigid frame within the housing for providing structure to the housing and a securing mechanism which is arranged to pull the door inward towards the opening for engagement thereon. The securing mechanism has at least one shaft generally vertical in orientation located within the housing on the frame and a cam within the housing on each end of the shaft having an end which is coupled to the rail assembly such that rotation of the shaft forces the door inward on the opening.

The present invention relates to a sealable door for example for a rail car of a type which is arranged to tighten towards the rail car so that the door is sealed and locked.

### BACKGROUND OF THE INVENTION

Freight box rail cars and the like are used to transport items across distances which vary in environment and topography. The doors on rail cars are generally mounted on rails which allow a door to slide horizontally to allow access to the inside of the rail car or to restrict access to the inside of the rail car. These doors are relatively large in stature and are made of metal since the loads carried within the rail cars can be large so the doors must be able to accept large items. The doors must also be durable due to the movement of the items within the rail car during transportation and due to the conditions surrounding the rail car during transportation. The conditions can consist of the elements such as rain, snow, wind and other weather conditions which can damage the items, and the conditions can consist of animals such as rodents entering the rail car which also can damage the items. A rail car door must also be able to be locked so that the items within the car are protected from theft and the like.

Some examples of doors of this type are found in U.S. Pat. No. 3,978,618 (Malo), U.S. Pat. No. 4,114,935 (Malo), U.S. Pat. No. 4,608,777 (Okamoto), U.S. Pat. No. 4,751,793 (Jenkins et al), U.S. Pat. No. 3,788,007 (Bailey), U.S. Pat. No. 4,091,570 (Favrel) and U.S. Pat . No. 5,142,823 (Brandenburg et al) which in general disclose a sliding door or the like arranged to enclose an area such as a rail car. The doors do not create a seal about an entrance so that water or the like may not enter, so that if a load such as paper is being hauled within the car, it is not protected and could be damaged. The doors have a locking device for locking the door either to close or to open an entrance. Another example of a sliding door of this type which does provide a seal is in U.S. Pat. No. 5,647,558 (Kober) which is arranged to provide a sealing door construction for a purpose built rail car. However this is not suitable for replacement type door on an existing sliding door type rail car.

Some examples of locking devices are shown in U.S. Pat. No. 4,852,918 (Allen), U.S. Pat. No. 4,763,385 (Furch et al), U.S. Pat. No. 3,820,283 (Acerra et al), U.S. Pat. No. 4,776,619 (Daugherty et al), U.S. Pat. No. 4,296,956 (Colombo) U.S. Pat. No. 5,056,835 (Johnson) and U.S. Pat. No. 5,302,072 (Stauffer et al).

### SUMMARY OF THE INVENTION

It is one object of the present invention to provide an improved rail car door.

According to a first aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a sliding door member mounted on top and bottom rails at the opening extending parallel to a plane of the opening with the door movable from a closed position at the opening to an open position spaced along the rails from the opening;

the sliding door member including side beams, a top beam and a bottom beam which co-operate respectively with the side posts, top beam and bottom sill respectively in a sealing action;

each of the side beams, top beam and bottom beam of the sliding door including a sealing surface parallel to the sealing plane for sealing with the respective sealing surface by a compressible sealing member therebetween;

the sliding door member including an interior sheet extending to the beams and lying in a vertical plane;

each of the beams including a front wall parallel to the interior sheet, an outer side wall joining the front wall and the interior sheet and an inner side wall joining the front wall and the interior sheet;

pivotal mounting members mounting the door member on the rails for movement of the door in a direction transverse to the rails so as to move the door in the closed position inwardly toward the opening from an outer sliding position to an inner sealed position to effect sealed closure within the opening; and

an actuation system for effecting actuation of the pivotal mounting members comprising a pair of vertical shafts each having a respective one of the pivotal mounting members at its upper end and at its lower end, each of the shafts being contained within a respective one of the side beams mounted therein for rotation about its axis.

According to a second aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a sliding door member mounted on top and bottom rails at the opening extending parallel to a plane of the opening with the door movable from a closed position at the opening to an open position spaced along the rails from the opening;

pivotal mounting members mounting the door member on the rails for movement of the door in a direction transverse to the rails so as to move the door in the closed position inwardly toward the opening from an outer sliding position to an inner sealed position to effect sealed closure within the opening;

an actuation system for effecting actuation of the pivotal mounting members;

the sliding door member including side beams, a top beam and a bottom beam which co-operate respectively with the side posts, top beam and bottom sill respectively in a sealing action;

the sliding door member including an interior sheet extending to the beams and lying in a vertical plane;

wherein the door member is formed in two separate pieces connected together, each piece including one beam and part of two of the beams at right angles to that beam together with a part of the interior sheet.

According to a third aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a sliding door member mounted on top and bottom rails at the opening extending parallel to a plane of the opening with the door movable from a closed position at the opening to an open position spaced along the rails from the opening;

pivotal mounting members mounting the door member on the rails for movement of the door in a direction transverse to the rails so as to move the door in the closed position inwardly toward the opening from an outer sliding position to an inner sealed position to effect sealed closure within the opening;

an actuation system for effecting actuation of the pivotal mounting members;

the sliding door member including side beams, a top beam and a bottom beam which co-operate respectively with the side posts, top beam and bottom sill respectively in a sealing action;

the sliding door member including an interior sheet extending to the beams and lying in a vertical plane;

and air inlet openings in the door member arranged to cause air to be forced therethrough by travelling movement of the rail car and to direct the air into the rail car.

According to a fourth aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a bottom rail;

a sliding door member mounted on the bottom rail at the opening extending parallel to a plane of the opening with the door movable from a closed position at the opening to an open position spaced along the rails from the opening;

pivotal mounting members mounting the door member on the bottom rail for movement of the door in a direction transverse to the rails so as to move the door in the closed position inwardly toward the opening from an outer sliding position to an inner sealed position to effect sealed closure within the opening;

an actuation system for effecting actuation of the pivotal mounting members;

each pivotal mounting member including a roller carriage for rolling movement along the rail, the roller carriage having a housing with side plates and a pair of rollers mounted in the housing between the side plates with one roller in front of the other and aligned for sitting on a top surface of the rail, the housing defining a slot between the side plates through which the top surface of the rail passes such that the rail is cleaned of debris by the slot as the carriage moves along the slot, the housing having on an inside surface of each of the side plates a low friction wear-resistant plastics liner material for running along a respective side surface of the rail.

According to a fifth aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a sliding door member mounted on top and bottom rails at the opening extending parallel to a plane of the opening with the door movable from a closed position at the opening to an open position spaced along the rails from the opening;

pivotal mounting members mounting the door member on the rails for movement of the door in a direction transverse to the rails so as to move the door in the closed position inwardly toward the opening from an outer sliding position to an inner sealed position to effect sealed closure within the opening;

an actuation system for effecting actuation of the pivotal mounting members;

the sliding door member including two side beams, a top beam and a bottom beam which co-operate respectively with the side posts, top beam and bottom sill respectively in a sealing action;

each of the side beams, top beam and bottom beam of the sliding door including a sealing flange extending outwardly from the beam defining a sealing surface parallel to the sealing plane for sealing with the respective sealing surface by a compressible sealing member therebetween;

the sliding door member including an interior sheet extending to the beams and lying in a vertical plane; and

each of the beams having a front wall parallel to the interior sheet and an outer side wall joining the front wall and the interior sheet.

According to a sixth aspect of the present invention there is provided a sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;

the sliding door comprising:

a sliding door member mounted on top and bottom rails at the opening extending parallel to a plane of the opening with the door movable from a closed position at the opening to an open position spaced along the rails from the opening;

pivotal mounting members mounting the door member on the rails for movement of the door in a direction transverse to the rails so as to move the door in the closed position inwardly toward the opening from an outer sliding position to an inner sealed position to effect sealed closure within the opening;

an actuation system for effecting actuation of the pivotal mounting members; and

a latching mechanism supported on each of the side posts including at least one slide member mounted for sliding movement between a latched position in which said at least one slide member is received within a respective latching aperture in the sliding door member with the sliding door member in the inner sealed position and a released position in which said at least one slide member is disengaged from the sliding door member.

### BRIEF DESCRIPTION OF THE DRAWINGS

Embodiments of the invention will now be described in conjunction with the accompanying drawings in which:

FIG. 1 is a front elevational view of one embodiment of rail car door according to the present invention.

FIG. 2 is a partial vertical cross section along the lines 2-2 in FIG. 1 showing the top, middle and bottom portions of the present invention.

FIG. 3 is an isometric view of a rail and door mounting member of the embodiment of FIG. 1.

FIG. 4 is a vertical cross section along the lines 2-2 in FIG. 1 showing the bottom portion only.

FIG. 5 is a vertical cross section along the lines 2-2 of FIG. 1 showing the top portion only.

FIG. 6 is a cut away partial isometric view of a second locking arrangement of the present invention.

FIG. 7 is an isometric view of a receptacle in which the door of FIG. 1 is mounted.

FIG. 8 is a partly exploded isometric view of a second embodiment of the door structure of the present invention.

FIG. 9 is an isometric view of the reinforcement members and actuating system only of the door structure of FIG. 8.

FIG. 10 is a schematic illustration of a part only of the door structure of FIG. 8 showing the operation of the ventilation system.

FIG. 11 is a partly exploded isometric view of a third embodiment of the door structure of the present invention very similar to that of FIG. 8.

FIG. 12 is a vertical cross sectional view through the door of FIG. 11 installed in place on a rail car and in an closed but sliding position.

FIG. 13 is a vertical cross sectional view similar to that of FIG. 12 through the door of FIG. 11 showing only a bottom part of the door on an enlarged scale.

FIG. 14 is a vertical cross sectional view along the lies 14-14 of FIG. 13.

FIG. 15 is an isometric view of the lower part of the door, bottom rail guide carriage and bottom rail with the front panel broken away.

FIG. 16 is a side elevational view of the rail guide carriage of FIG. 15.

FIG. 17 is a vertical cross sectional view of the rail guide carriage of FIG. 15.

FIG. 18 is a top Plan view of the rail guide carriage of FIG. 15.

FIG. 19 is an isometric view of an inner side a further embodiment of the door structure of the present invention.

FIG. 20 is an isometric view of the outer side of the door structure of FIG. 19.

FIG. 21 is a side elevational view of the door structure of FIG. 19.

FIG. 22 is a front elevational view of yet a further embodiment of the door structure of the present invention which is very similar to the door structure of FIG. 19.

FIG. 23 is an isometric view of the latching mechanism as illustrated in the embodiment of FIG. 22.

FIGS. 24A, 24B and 24C are sectional views along the line 24-24 of FIG. 23 with the door structure shown in the outer sliding position, the inner sealed position and the latched position respectively.

FIG. 25 is a sectional view along the line 25-25 of FIG. 23.

In the drawings like characters of reference indicate corresponding parts in the different figures.

### DETAILED DESCRIPTION

A sliding door 1 is mounted a rail car 3 or the like for allowing access to the rail car through an opening 5 for storing and transporting goods and materials. The door is arranged to enclose the car by covering the opening and locking so that the car is sealed. A seal at the opening is important especially if the goods which are being transported cannot be exposed to the elements. For instance when transporting stereo components or furniture, dust or water can severally damage the products, also theft is considered a major problem for distributors and the like since the products can be stolen when the train is stopped for loading or unloading and the like.

The door is also arranged to be lockable in the open position as well as in the closed position. Locking the door in the open position will help prevent accidents which involve the door closing when workers are loading the car. These accidents, generally, happen because of connecting more car to the train while some cars are being unloaded since the force of a car attaching to the train causing the train to jerk slightly which can cause the door to close. Many times an operator is located in the opening when the door accidentally closes which can harm the worker.

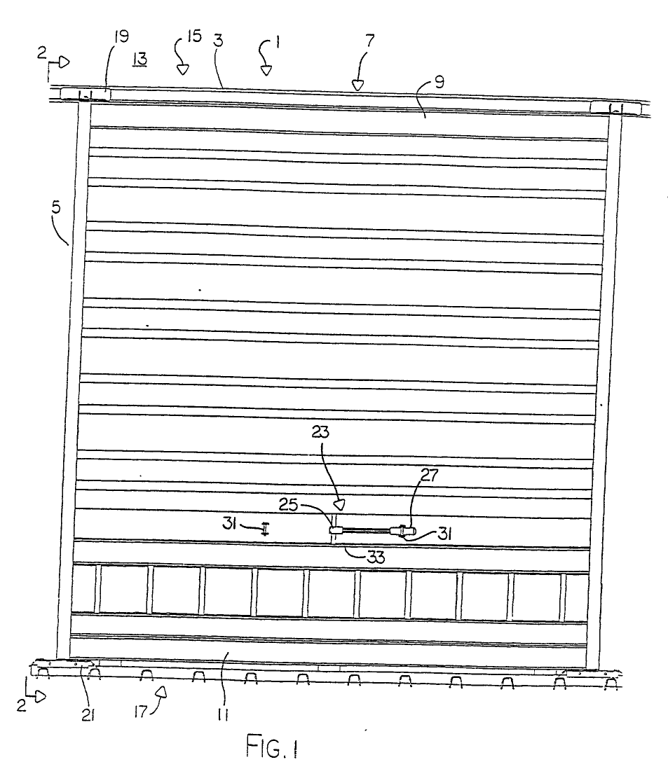

FIG. 1 shows front view of the door in the closed position on the rail car. The door is supported on the rail car by a rail assembly 7 which is located at a top end 9 and a bottom end 11 of the door and is coupled to a housing 13 of the rail car. The rail assembly comprises a first rail system 15 and a second rail system 17. The first rail system 15 is located above the door and extends horizontally on the housing and is arranged to receive a first set of guides 19 which are coupled to the door for connecting the door to the first rail system. The second rail system 17 is located below the door and extends horizontally on the housing parallel to the first rail system and is arranged to receive a second set of guides 21 which are coupled to the door for connecting and supporting the door to the second rail system. The second rail system is arranged to support most of the weight of the door and the first rail system is arranged to support the vertical stature of the door, as described later in detail.

The door is locked by a securing mechanism, generally indicated by, 23. The securing mechanism comprises a rotation device 25 which has a first position 27, shown in FIG. 1, and a second position, not shown. In the first position the rotation device, as shown in FIG. 1, is a handle 29 which is locked in position by a lock 31 so that the door is secured in the closed or opened position. A pad lock or the like can be attached to the lock for added security from theft and the like.

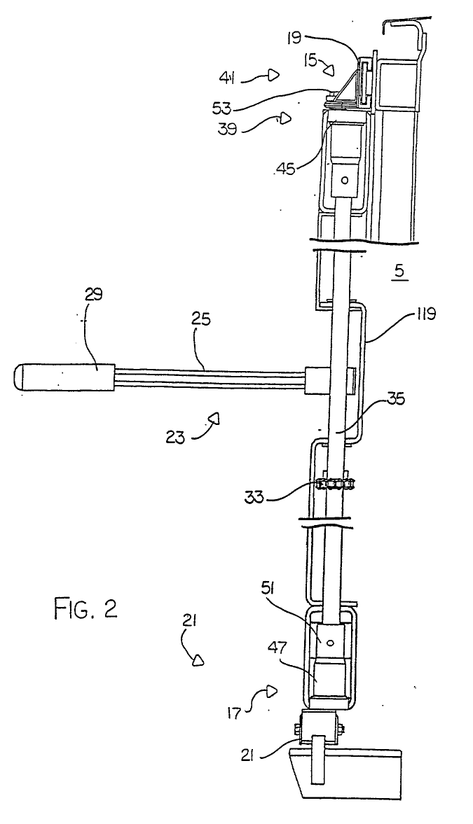

FIG. 2 shows the securing mechanism of the door. The door also has a construction which has a plurality of channels 119 for added strength to the door. The doors are designed to be light in weight yet still be strong enough to receive a fork from a fork lift or the like. The door has a bar, not shown, which is arranged such that the doors can be opened by a fork lift or the like for loading and unloading. The securing mechanism comprises the rotation device, as mentioned above, a drive mechanism 33 and a vertical shaft 35. The drive mechanism is arranged to rotate the shaft about an axis 37. The drive mechanism is coupled to the rotation device such that movement of the rotation device actuates the drive mechanism, the rotation device pivots about a vertical axis which rotates a drive shaft having a wheel which engages the drive mechanism which extends horizontally from the drive shaft.

The shaft is located at a respective end of the door and has a cam arrangement 39 at a top end 41 and at a bottom end 43. The cam arrangement is mounted to the rail assembly at respective ends of the shaft. The cam arrangement consists of a first cam 45 mounted on the top end and a second cam 47 mounted on the bottom end such that the cams are coaxial. The cams have a vertical axis 49 which is parallel to the axis of the shaft. A housing 51 of the cam arrangement is mounted on the shaft for supporting the cams to the shaft. The cams are arranged to rotate on the vertical axis 49 when the shaft is rotated by the drive mechanism. The axis of the shaft rotates about the vertical axis of the cams which moves the shaft inward or outward relative to the direction of the drive mechanism. The housing is arranged to engage the rail car at an outer edge of the opening for sealing the door on the car. When the shaft is rotated in a forward direction by the drive mechanism, the cam which is mounted to the rail system by a cam shaft 53 at an outer edge 55 of the rail system, the shaft rotates about the axis of the cam so that the shaft moves inward towards the car such that the cam is at a top dead center position when fully engaging the door for a constant sealing of the opening. The rotating device is at that point engaging the door so that the lock can be applied to the handle for locking the door in place. Thus each end of the shaft has an actuating shaft portion 53 which extends from an end of the shaft within the area defined by the cam and extends axially of the shaft and so as to be aligned with the shaft. The shaft portion is directly connected to the respective rail member and is slightly offset from the axis of the shaft while lying within the area of the cam such that rotation of the shaft forces the door inwardly of the opening. This arrangement of the shaft portion 53 provides a small movement at high force to generate high sealing forces against the opening to the car.

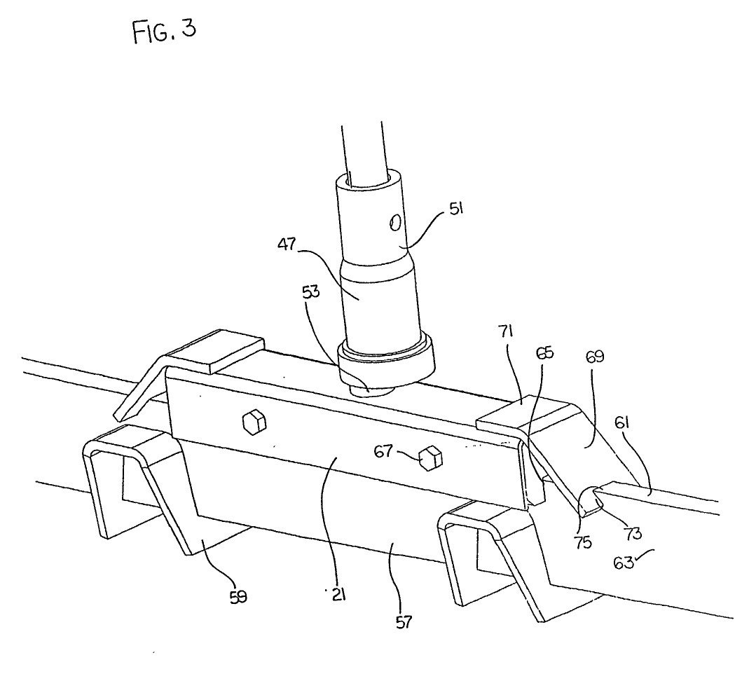

FIG. 3 shows the second cam at the bottom end of the shaft. The axis of the cam is parallel to the axis to the shaft but is arranged to be off set in manner such that the shaft rotates about the vertical axis of the cam.

The rail system at the bottom end of the shaft is shown in FIG. 3, wherein the rail system includes a rail 57 and rail support arms 59. The rail has a two first sides 61, defining a top and bottom side, and a second side 63, defining front and back sides. The first side is smaller in width than the second side, the rail support arms are attached to the second sides and are substantially U-shaped and are mounted to the car so that the rail is located slightly away from the side of the car for movement of the door. The second guide 21 is located on the top side and has a channel 65 which is substantially U-shaped for receiving the rail. The rail has wheels located within the guide at the channel for movement along the rail, which are fastened by bolts 67 which show the general location of the wheels. A scraping device 69 is attached to the guide and is arranged to scrape any unwanted materials from the rail so that movement of the door is unhindered. The scraping device is located at respective ends of the guide and is attached to the guide at a top end 71 and extends downwardly at an incline and engages the rail at a bottom end 73 which has a substantially U-shaped slot 75 in which the rail is received such that the top side and the a portion of the second sides are scraped to remove material on the rail. The guide is mounted on the rail so that is moveable in a side to side direction, defining the sliding movement of the door, so that when the door is pulled inward against the car the guide is positioned stationary which allows the door to seal the opening.

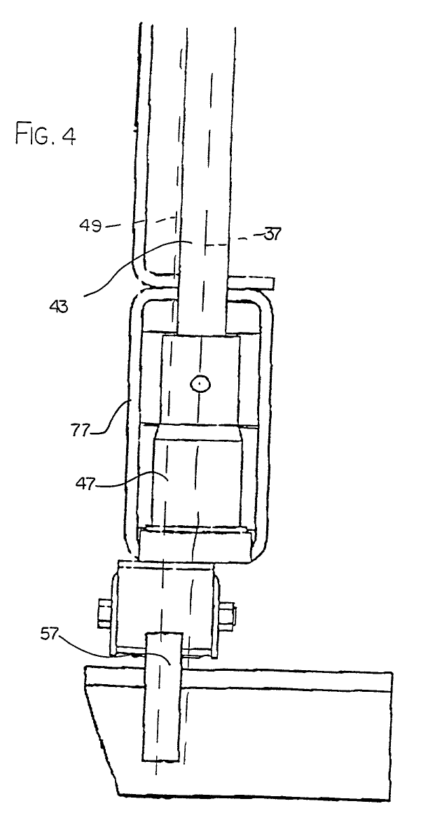

FIG. 4 shows the bottom end of the shaft. The door has a housing 77 in which the shaft is located. The housing covers the cam so that the majority of the securing mechanism is located within the door for protection against the elements.

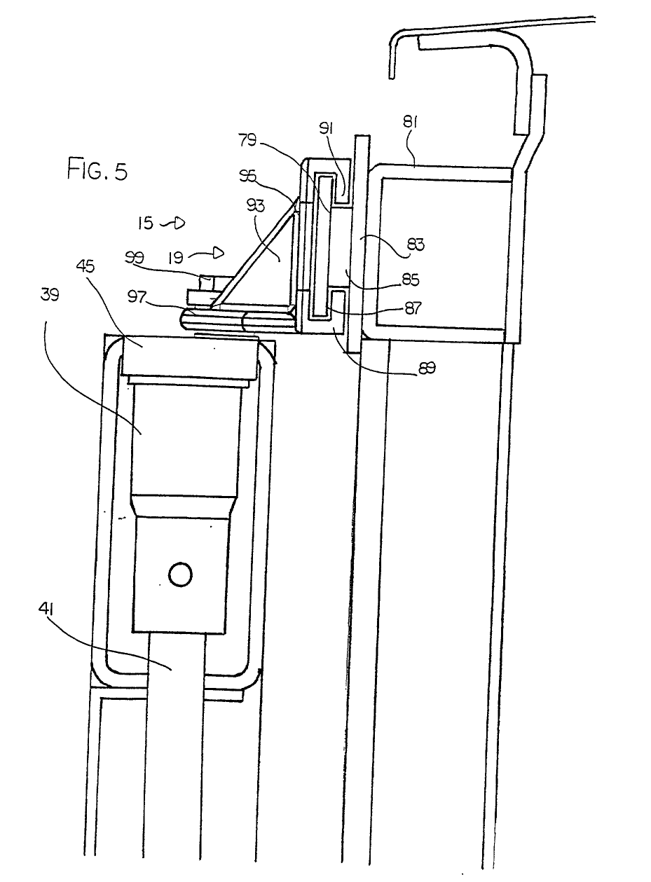

FIG. 5 shows the top end of the shaft and the first rail system. The first rail system includes a rail 79 which is mounted parallel to the rail at the second rail system on a rail bar 81 of the car. The rail is vertically mounted and extends horizontally along the car. The rail is substantially H-shaped wherein a first portion 83 attached to the rail bar, an abutment 85 extending outwardly from the center line of the first portion and an outer edge 87 parallel to the first portion on the abutment in which the first guide is located. The first guide consists of a C-shaped mount portion 89 which is mounted on the outer edge 87 of the rail. The mount portion is arranged to surround the outer edge and has a top and bottom flange 91 which is adjacent to the abutment such that the guide is limited in movement away and towards the door. An angle portion 93 is attached to the back side 95 of the mounted portion wherein a cam mount ledge 97 is located. The cam mount ledge is arranged such that the cam shaft can be attached by a bolt 99 for rotation on the axis. The first cam is located within the housing of the door such that when the securing mechanism is engaged in the lock position the housing engages the opening of the car for creating a seal. The first cam in FIG. 5 is in the unlock position wherein the cam is located at top dead center away from the car so the door can be slide away for access to a interior of the car for loading and the like.

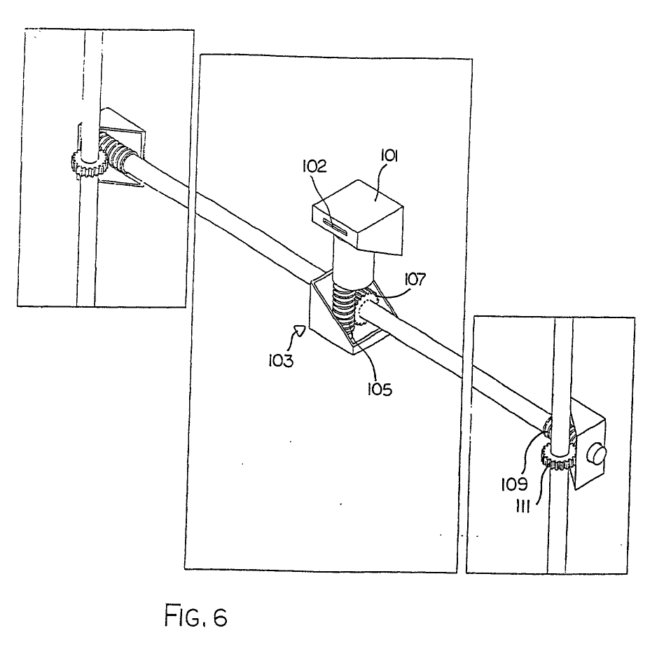

FIG. 6 shows another embodiment of the rotation device wherein a card lock 101 is utilised so that a card inserted into a slot 102 actuates the rotating device to lock or unlock the securing mechanism. A wheel and worm combination 103 is utilised which comprises a first worm 105 on the rotation device engages a first wheel 107 of the drive mechanism. The first wheel is rotated by a mechanism within the card lock so that the first wheel is driven about a horizontal axis. The first wheel is coupled to a horizontal shaft which is rotated about the horizontal axis when the card lock is actuated. At respective ends of the shaft is a second wheel 109 which engages a second worm 111 on the shaft. Rotation of the horizontal shaft drives the second wheel such that the shaft is rotated about the axis of the cam, as mentioned above. The horizontal shaft including the wheel and worm combination is located within the housing of the door for protection from the elements.

In another embodiment, the door is mounted within a receptacle 113, as shown in FIG. 7. The receptacle is arranged such that the door is located on the car and such that the door is inline with the cars walls and does not hang out of the perimeter of the car. The receptacle has a first portion 115 which is arranged to receive the door when the door is closed and a second portion 117 which is arranged to receive the door when the door is open. The receptacle is arranged such that the doors are located within the receptacle so as to prevent the doors from swinging open acting as a stopper. The doors are arranged to move out of the receptacle when being open and closed.

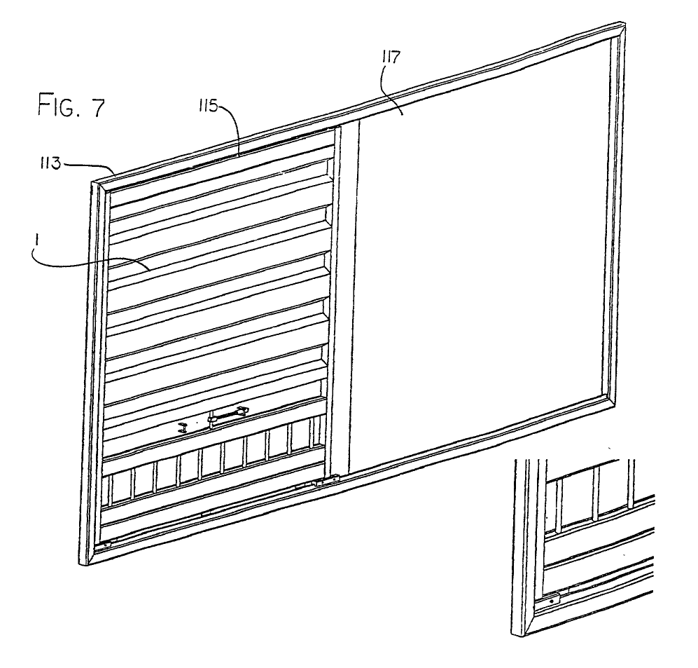

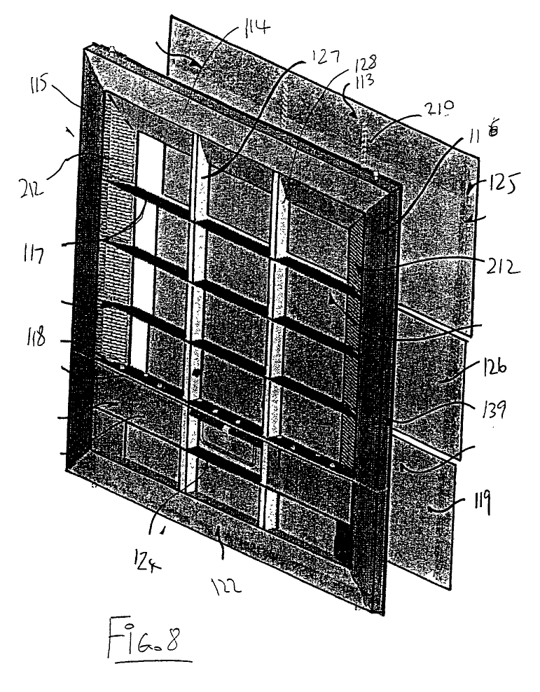

In FIGS. 8 through 16 is shown a further modified embodiment. FIGS. 8 and 9 show a slightly different construction from that in the remaining figures but the principles of construction are the same. The following description concentrates upon the similarities in construction.

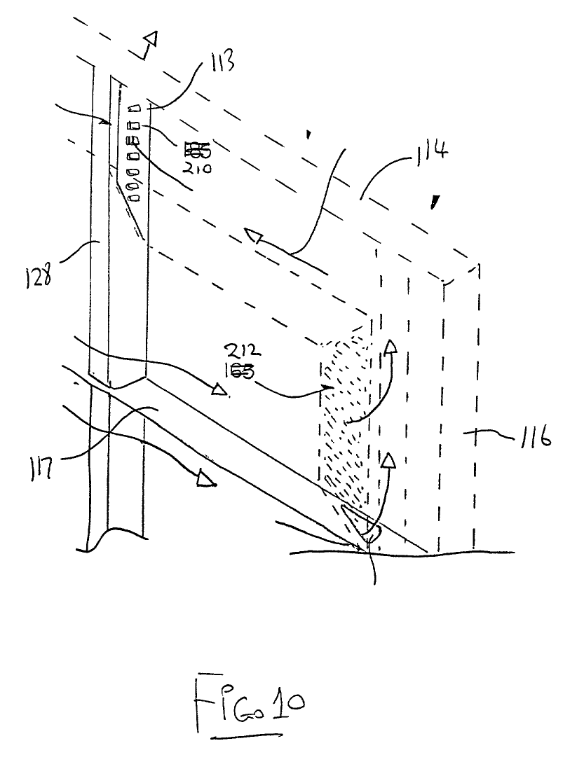

In FIGS. 8 and 11 are shown partly exploded views of the door construction. The door 110 for mounting on the rail car comprises two door sections including an upper section 111 and a lower section 112. The door sections when combined to form the complete door provide dimensions which have a height equal to the height of the opening in the rail car as discussed hereinafter and a width also equal to the opening in the rail car allowing the door to be inserted as a plug into the opening as described in detail hereinafter.

The upper section 111 is formed from a back sheet 113, a top beam 114 and two side beams 115 and 116. The upper section further includes transverse stiffening members 117 in the form of flat horizontal plates arranged at spaced positions along the height of the section from the top beam 114 to a bottom one 118 of the horizontal plates at the bottom of the upper section.

Similarly the bottom section 112 has a back sheet 119 and two post sections 120 and 121 which co-operate with the post sections 115 and 116 to form a complete vertical beam extending along the full height of the door when the door is assembled. The bottom section further includes a bottom beam 122 similar to the top beam 114. The cross section of each of the beams around the periphery of the door is substantially identical as described in more detail hereinafter. The beams are mitred together so that the bottom beam 122 is mitred to the bottom of the beam sections 120 and 121 and similar to the top beam 114 is mitred to the top of the side beams 115 and 116.

The bottom section 112 further includes one or more horizontal stiffener members in the form of flat plates 123. In the embodiment of FIG. 11 the bottom section 112 has a single transfer stiffener plate 123 at its top edge. In the embodiment of FIG. 8 the bottom section has a top stiffener plate 123 and a second stiffener plate 124 halfway between the top stiffener plate 123 and the bottom beam 122.

In FIG. 11 the back sheet 113 of the upper section is formed as a single piece extending from the top edge of the top beam 114 to the bottom plate 118. In FIG. 8, the back sheet is formed in two sections 125 and 126. It will be appreciated that this differences provides little structural change. The upper and lower sections further include vertical stiffener members 127 and 128. These are formed as channel members with a front face lying in a front common plate with a front face of the beams and two side walls inclined rearwardly and outwardly from the front face to a rear edge at the back sheet 113. The vertical stiffeners 127 and 128 are formed in separate individual sections each extending from a horizontal member to the next horizontal member. Thus some of the sections connect from one of the beams to the next adjacent plate and similar sections are connected between the individual plates.

The back sheet 113 of the upper section and the back sheet 119 of the lower section each include an inturned side flange 130 extending from the edge forwardly of the back sheet into the interior of the structure for co-operating with the respective beam. Thus the flange extends along each side and along the top of the upper section 113 and extending along the bottom and sides of the bottom section 119.

The stiffener plates 117, 118 and 123 extend along the full length of the door structure from one side flange of the back sheet to the opposite side flange of the back sheet and also extend through the thickness of the door structure from the back sheet to the front plane of the door. Thus each of the side beams 115 and 116 has formed in an inner side wall a plurality of slots 131 so that the slots receive the stiffener plates allowing the inner surface to slide over the plates to the back sheet.

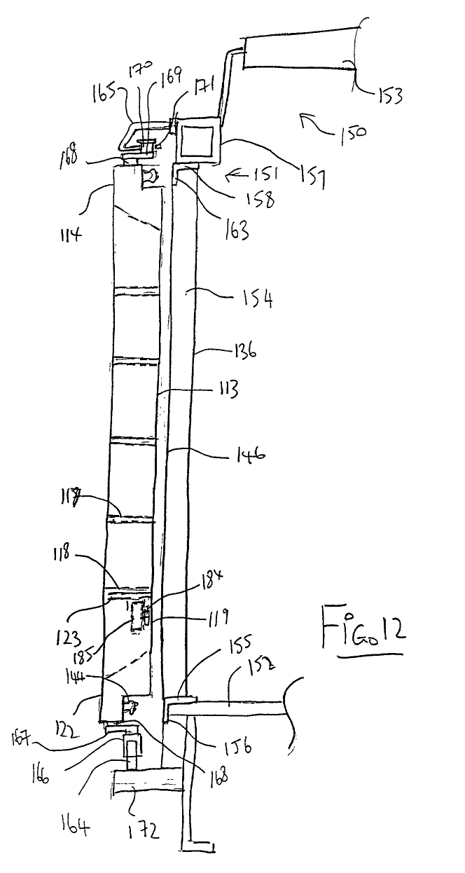

The cross section of the beams is shown in more detail in FIGS. 13 and 14. In FIG. 13 the bottom beam 122 is shown and is substantially identical in cross section in the top beam 114. In FIG. 14 the side beam 115 is shown and is substantially identical to the side beam 116. It will be noted that the cross section of the side beams is substantially equal to the cross section of the top and bottom beams so that they can be connected at the mitred joint at the four corners.

The beam is thus formed generally into a channel shape with a front wall 132, an outer side wall 133 and an inner side wall 134. The front wall 132 lies in a common plane with the front edge of the stiffener plate, with the other front walls of the other beams and with the front wall of each of the vertical stiffener members 127, 128. The front plane 135 is thus spaced forwardly from a plane 136 of the rear wall 113 by a distance equal to the thickness of the door.

The inner wall 134 of each of the beams is sloped or inclined so that it commences at an outer edge 137 at the front wall and extends rearwardly and inwardly to a rear edge 138 at the rear plate 113. Thus each of the beams has the inner side wall converging inwardly with the angles being substantially identical to form a dished front section extending from the front plane 135 rearwardly to the rear plane 136. The stiffener members 127 and 128 have the side walls at an angle substantially equal to the angle of the inner side walls of the beams to provide an attractive appearance. The upper ends of the stiffener members 127 and 128 are also mitred so as to match the slope of the inner side wall of the top beam and a similar arrangement is provided at the bottom beam. The outer side wall 133 defines a rearwardly extending first portion 139 which extends to a transverse second portion 140 which in turn is connected to a rearward extending third portion 141. The length of the flange 130 of the rear plate is equal to the length of the third portion 141 so that one overlies the other allowing the rear plate 113 to be welded at the flange 130 to the outer side wall to form an interconnected structural member.

The transverse walls 140 all lie in a common sealing plane 142 parallel to the planes 135 and 136 and partway therebetween with all of the portions 140 of the beams lying in the same sealing plane 142. The width of the second wall portion 140 is sufficient to receive a compressible sealing strip 144. Various types of sealing strip are available commercially and the example shown comprises a hollow tube with a front face 145 for butting against a sealing plane 146 of the rail car as described hereinafter. Thus the three portions of the outer side wall define a stepped section where the outer portion at the wall portion 133 overlies the corresponding rail or post of the rail car and the inner section defined by the wall 141 lies inwardly of the edge of the opening of the rail car and projects through the opening into the interior of the rail car.

The upper section 111 of the door is arranged so that its height from the bottom plate 118 to the top wall portion 139 of the top beam 114 is equal to substantially the maximum shipping width or height allowing the upper section to be transported as a single piece using standard trailers. As the height of the rail car is often significantly greater than the normal shipping width of eight feet, the door is formed in two sections so that the lower piece is separated for shipping and transported separately for assembly at the rail car location.

In addition the lower section is fabricated to form a stronger section able to withstand and accommodate more vigorous action for example from the forks of fork lift trucks which often can impact the lower section when the car is being unloaded. For this reason, the lower beam sections 120 and 121 together with the bottom beam 122 are formed from thicker material than are the corresponding pieces of the upper section of the door. Yet further, at the upper edge of the inner wall 134 of a bottom beam 122 is provided an additional sheet 146 which lies against the rear sheet 119 of the bottom section. In this way the rear sheet is in effect formed from two sheets of material with the inner sheet 146 being thicker than the rear sheet 113 so as to provide more than double the strength of the rear sheet in the lower section of the door. In this way forks from a fork lift tending to impact the lower section of the door will slide over the sloped inner wall 134 onto the rear sheet which is sufficiently strengthened by the double thickness and thicker material to withstand significant impact forces from the fork.

The upper and lower sections are connected together by bolting the plate 118 to the plate 123 and by straps 109 which are attached to the sides of the side beams 115 and 116 and bridge the connection to provide rigidity to the assembled construction.

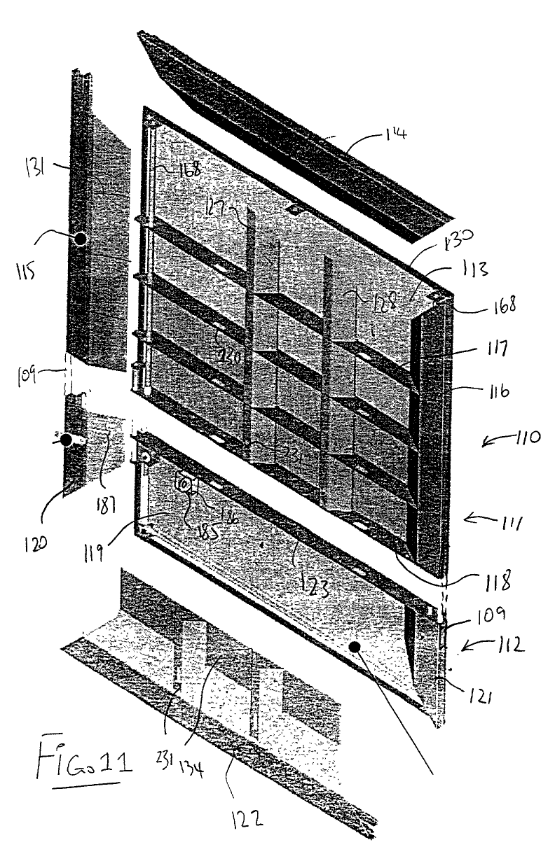

In FIG. 11 is shown the door mounted in a rail car 150 at an opening 151. The construction of the rail car is well known and the present invention is primarily concerned with a door suitable for replacement of existing simple sliding doors without a plugging action so that the car can be sealed against weather penetration simply by replacing the sliding door and its mounting arrangement with the modified sliding and plugging door and its new mounting arrangement as shown particularly in FIG. 12. The rail car includes a floor 152 and a roof structure 153. The frame structure and wheel arrangement are not shown since these are well known to one skilled in the art. The opening 151 is defined by a pair of side posts 154. At the bottom the opening is defined by a sill member 155 which overlies an edge of the floor and defines a vertical flange 156 covering the floor edge. At the top the opening is defined by a horizontal header 157 to which is added a horizontal header edge member 158 extending along the underside of the header and defining the upper edge of the opening.

Specific arrangements of the posts, sill and header can vary for different types and arrangement of rail car. However, in all cases the header member 158, the sill member 155 and the posts are arranged to define the sealing plane 146 at the front surface of the posts and the front surfaces of the sill and header. All of these surfaces are arranged to lie in the common plane so that they can seal against the sealing strip 144 carried on the second portion 140 of the sidewall of the door.

As shown in FIG. 14, the inner sheet 113 in the sealed position is arranged to lie in a common plane with the inside surface of the posts 154 which is in a common plane with the side wall 160 of the rail car. The front face 161 of the post is therefore forward of the plane 136. The sill is thus arranged so that the flange 156 lies in a common plane with the front edge 161 of the posts and similarly the header edge 158 includes a downwardly depending flange 163 which lies in the same common plane.

In the sealed position shown in FIG. 14, the sealing strip is compressed to provide a sealing action and the inside portion of the door projects into the interior of the opening so that the back sheet 113 lies in a plane 136. In the unsealed position shown in FIG. 12, the door is backed out of the opening so that the back sheet 113 is clear of the front edge of the post allowing the door to slide longitudinally of the side of the rail car from a position at the opening to a position spaced beyond the opening to allow loading access through the opening.

The door is, in order to provide this movement, carried on a bottom rail 164 and a top guide 165 which are arranged in a sliding plane along the rail car outwardly of the opening allowing sliding action of the door. The door moves inwardly and outwardly relative to the rail and the guide by a cam and shaft drive arrangement by which rotation of the shaft causes a cam movement at the top and bottom of the door to force the door inwardly and outwardly between the sealed and unsealed positions.

The rail 164 supports a carriage 166 for rolling along the rail and that carriage is connected to the door by a cam 167 connected to the bottom end of a shaft 168. The same shaft at its upper end carries a cam 169 with a roller 170 carried in a slot 171 in the guide 165. The guide 165 thus includes a horizontal upper portion together with a parallel lower portion within which the slot 171 is provided so that the roller 170 projects through the slot in the lower portion and is protected underneath the upper portion. The guide 165 is mounted on a bracket attached to the header 157.

The rail 164 is carried on a suitable horizontal support 172 underneath the opening and attached by suitable frame elements to the side of the car.

As shown in FIGS. 9 and 11 there are two shafts 168 each arranged within a respective one of the side beams 115 and 116 of the door. Each shaft has at its upper end a respective one of the cams 169 and has at its lower end a respective one of the cams 167.

Each shaft 168 is divided into two portions including a lower portion 173 within the lower portion of the door and an upper portion 174 within the upper portion of the door. For assembly, the lower portion 173 includes a stub shaft portion 175 projecting outwardly above the plate 123 which is non circular in cross section so as to co-operate with a sleeve type receptacle 176 which has a corresponding cross sectional shape to allow communication of rotation from the lower portion to the upper portion for common movement of the upper and lower cams. The shaft is mounted within a bearing collar at each plate 117 and these are mounted within a separate bearing plate 177 at the bottom wall 139 and within a bearing housing 178 at the plate 123 of the bottom section of the door. At the bearing 178 is provided a wheel 179 of a worm and wheel drive arrangement for driving rotation of one of the shafts 168. The wheel 179 co-operates with a worm 180 supported for rotation about an axis 181 and carried on the back sheet 119 at a position just below the top plate 123. The worm 180 is driven by a sprocket 182 carried on the worm and driven by a chain 183. The chain 183 is driven by a sprocket 184 carried on the shaft of a handle 185 mounted on the bottom portion of the door just under the plate 123 as shown in FIG. 11 adjacent the side post 115 but outside the inner side wall of the side post 115. The handle comprises a rotatable hand wheel which can rotate about a horizontal axis parallel to the axis 181 and the chain is located within a suitable chain housing 186 and communicates through an opening 187 in the side wall of the post portion 120 to drive the sprocket 182 and the worm 180.

Rotation of the left hand shaft 168 is transferred to the right hand shaft 168 by a pair of drive rods best shown in FIG. 14. Thus there is a drive rod 187 behind the shafts 168 and extending from one shaft to the other shaft and a second rod 188 symmetrical to the first and arranged in front of the shafts 168. Each of the drive rods is connected to the respective shaft at its respective ends by a lug 189, 190 projecting outwardly from the shaft the rods 187 and 188 are pivotally connected to the lugs 189, 190 so that the rods can move substantially longitudinally along the bottom beam 122 within that beam as shown in FIG. 13 while the lugs rotate around the axis 191 of the shaft. The rods are arranged so that they allow rotation of the shaft 168 through an angle limited to 90° until the binding action of the rod end on the shaft stops further movement. The rotation of the shaft through 90° therefore causes the cams at the end of the shaft to rotate through the same angle thus moving from a position inline with the bottom edge of the door to a position projecting outwardly at right angles so as to effect the movement from the unsealed to the sealed position of the door.

The hand wheel drive arrangement is only one example of a suitable drive mechanism for communicating drive through the shafts. Alternative mechanisms are shown herein before for powered drive action to the shafts. Other styles of manually operable handle can also be provided in the form of a hand crank or the like. The chain coupling can provide a mechanical advantage so that the hand wheel or hand crank can rotate a number of turns while the cams move through the 90°.

For example in FIG. 9 there is shown a drive mechanism 192 which is again located just underneath the top plate 123 of the bottom section of the door. In this case however, the drive communicates directly through rotating shafts to the individual shafts 168. In both embodiments the basic drive to the shaft 168 is effected by a worm and wheel arrangement which has the advantage that there is no back pressure against the worm by forces on the door tending to rotate the cams. Thus when the doors are moved to the sealed position, forces tending to move the door to the unsealed position are communicated into the shafts 168 but these forces are not communicated through the worm and wheel arrangement back to the handle with the possibility of the drive to the closure being reversed and allowing the door to move to the unsealed position.

The handle height is arranged in all embodiments just under the top plate of the bottom portion of the door since this height is located conveniently to allow a person standing on a platform at a height equal to the bottom of the door to reach down and operate the handle and in addition a person standing on the ground alongside the rail car can also reach up and operate the handle. A single handle therefore can be provided which allows operation of the door from the sealed to the unsealed position from either positions without the necessity for stepping up onto a step or the like and without the necessity for providing separate handles for the separate locations.

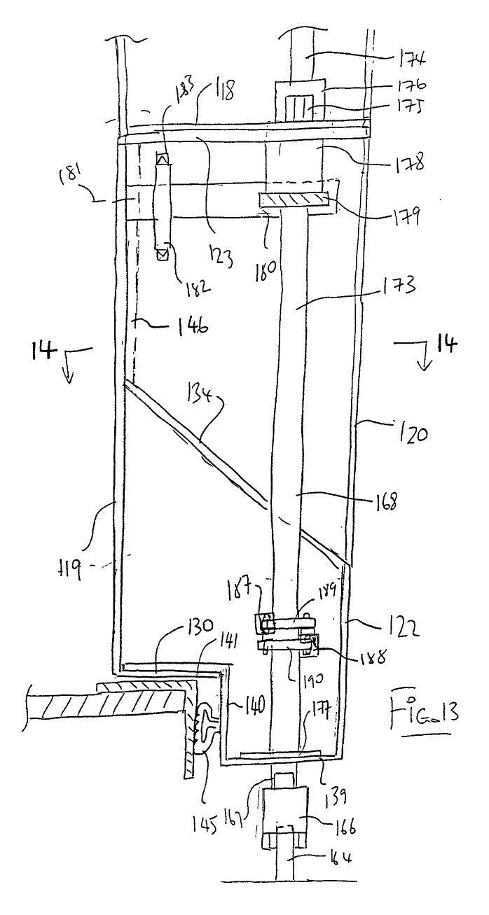

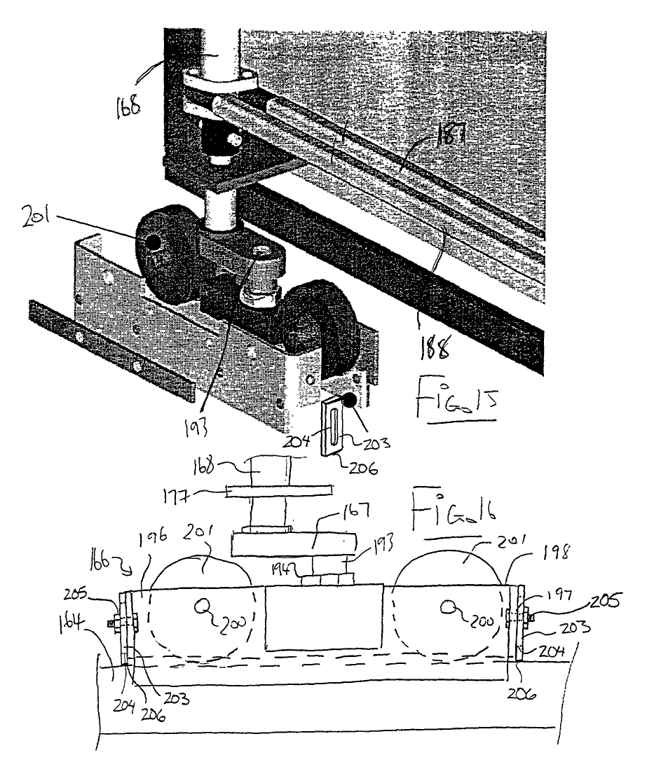

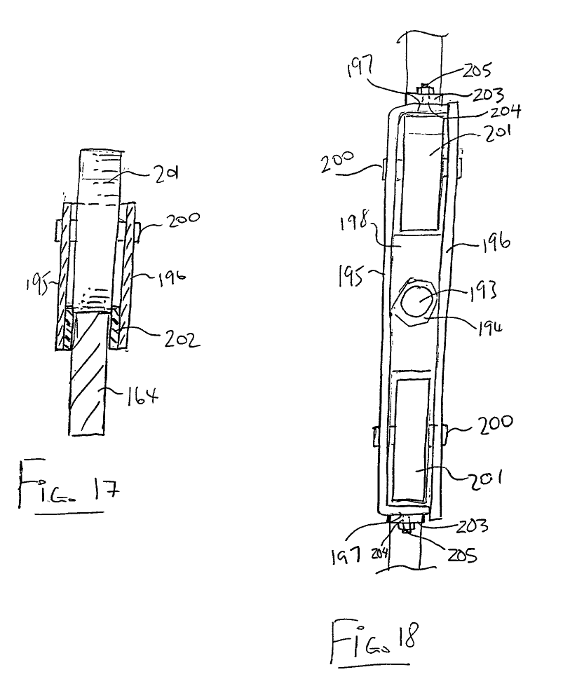

Turning now to FIGS. 15 through 18, there is shown the construction of the carriage 166 for rolling along the rail 164. The carriage is mounted at the bottom of the shaft 168 on the cam 167. The cam 167 defines a link rigidly connected to the bottom of the shaft 168 for rotation therewith and extending outwardly to one side of the shaft 168 to a post 193 extending downwardly from the cam 167 to the carriage 166. The post 193 includes a threaded section on which is provided a lock nut 194 allowing the height of the carriage relative to the cam link 167 to be adjusted so that the height of the door can be moved upwardly and downwardly relative to the carriage and thus upwardly and downwardly relative to the opening.

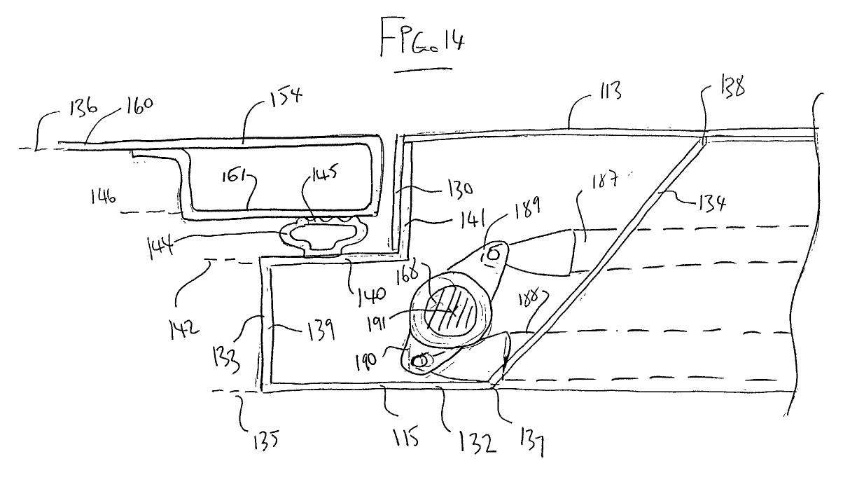

The carriage 166 comprises two side plates 195 and 196 with the ends of the side plate 195 being bent round at right angles as indicated at 197 to form an enclosed box with a open top at the top edge of the side walls and an open bottom. The side walls are mounted on a mounting block 198 bridging between the side walls and attached to the post 193. The block 198 includes a female screw thread into which the post 193 extends for locating the block on the post and for adjusting the height of the block relative to the post. The side walls carry a pair of transverse shafts 200 each carrying a respective roller 201 for rotation about the axis of the shafts. One roller is mounted on one side of the block 198 and the other is mounted on the other side of the block. The open top of the housing allows the upper part of the rollers to project through for cleaning and ready replacement since it always can simply be pulled upwardly after the shafts are removed. The bottom edge of the rollers is contained within the side walls 195 and 196 for rolling on the top edge of the rail 164. Thus in the rolling position as shown in FIG. 16 the side plates project downwardly to the sides of the rail beyond the top edge of the rail so as to run along respective sides of the rail. The end walls 197 are of a reduced height so that their bottom edge is above the top edge of the rail. On the inside surface of the side walls 195 and 196 is provided a strip 202 of a suitable wear resistant plastics material which thus can run along the side surface of the rail to accommodate side loads between the carriage and the rail. Thus the rollers which can also be formed of a plastics material and the side walls of the carriage provide a smooth rolling action of the carriage on the rail. In addition the projection of the sides along the side of the rail provides a cleaning action of the rail to sweep away any debris and to prevent it entering the area underneath the rollers.

The front and back end walls 197 each include a sweeper member 203 mounted thereon to sweep across the top edge of the rail and protect the rollers against the penetration and entry of debris which could accumulate within the housing. Each sweeper member 203 is an upright plate having a vertical slot 204 for receiving a suitable fastener 205 through the slot to mount the sweeper member on the respective end wall 197. The fastener 205 is secured to the respective end wall 197 and permits the sweeper member 203 to be adjustably supported on end wall. By vertically positioning the fastener 205 within the vertical slot 204, a bottom end 206 of the sweeper member 203 can be aligned for engagement with the top surface of the rail. As the bottom end 206 of the sweeper wears away, a height of the sweeper member 203 is repositioned vertically in relation to the rail to maintain alignment and engagement with the top surface of the rail over the life of the roller carriage.

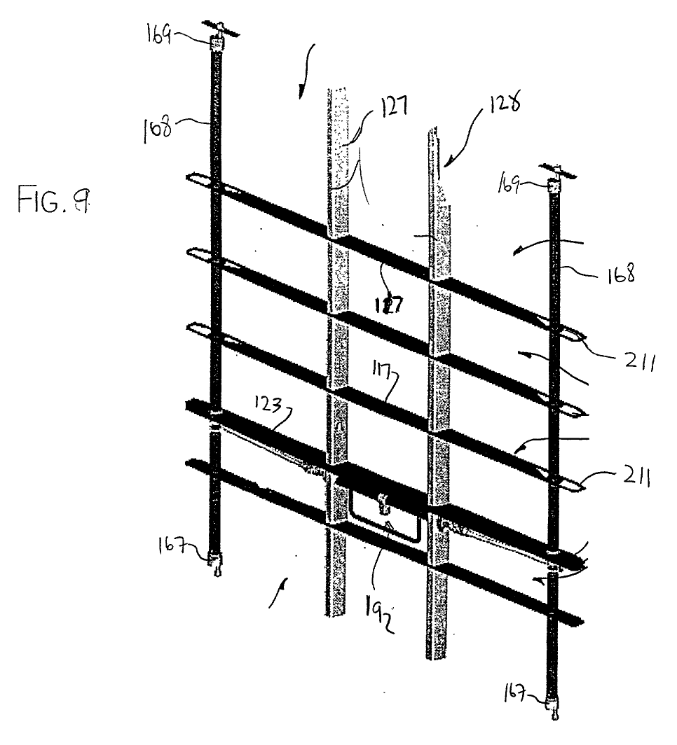

Turning now to FIGS. 8 and 10 there is shown an arrangement which will allow ventilation air to enter through the door for penetrating into the rail car. Ventilation is not essential in all constructions but can be provided where desired. The ventilation system is provided by communication of air through the peripheral frame of the door and into the vertical stiffener members 127 and 128. The air in the stiffener members communicates to openings 210 in the back sheet 113. Thus the sides posts 115 have on their inside wall a series of horizontal openings allowing air into the interior of the respective post. This air is free to flow upwardly through holes 211 in the plates 117. The air passes from the post 115, 116 through the miter joint into the top beam 114. In the arrangement with ventilation, the top beam has the inner side wall cut so as to communicate with the end of the vertical stiffener member 127, 128 allowing the air to enter the stiffener member and pass downwardly again through holes in the plates 117 so as to communicate with the holes in the back sheet 113. The openings in the inner side wall of the vertical beams 115 and 116 are indicated at 212 and are collapsible by a vertically slidable closure member which is similarly slotted so that it can move from a position where the slots are aligned to a position where the slots are misarranged thus effecting a closure of the slots in the side beam. In operation, depending upon the direction of movement of the rail car the slots in a vertical beam which is trailing relative to the direction of movement are opened and the others are closed so that the forward motion against the inclined sidewall forces the air inwardly into the vertical beam and thus forces into the interior of the rail car. In further ventilation arrangements, any type of ventilation housing can be mounted on the door in communication with openings in the back sheet to communicate air through the openings in the back sheet. The ventilation housing in any embodiment would be arranged to force air into the opening in response to forward motion of the rail car.

As shown in FIG. 11, the plates 117 have oval or elongate slots or holes 230 formed therein adjacent the front edge to act as handgrips to allow an operator to grasp the door and manually slide the door from the closed position along the rail car to the open position. Similarly the front face of each of the vertical reinforcing members 127 and 128 includes similar slots 231 extending upwardly along the front face to act again as hand grips for an operator.

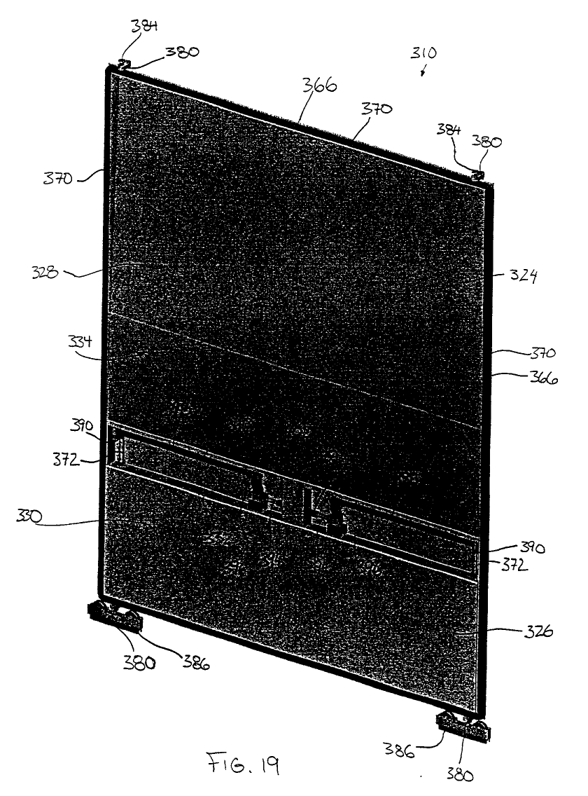

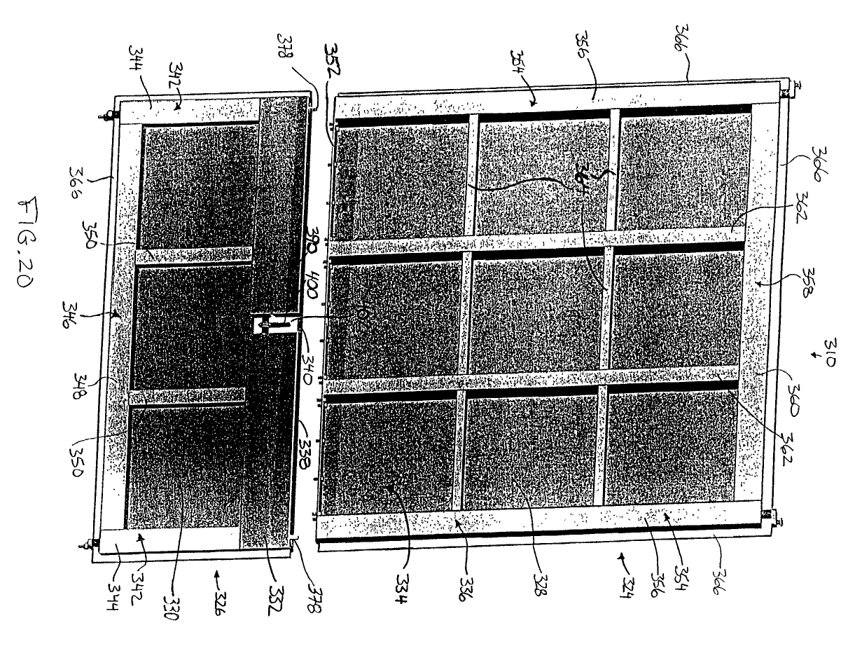

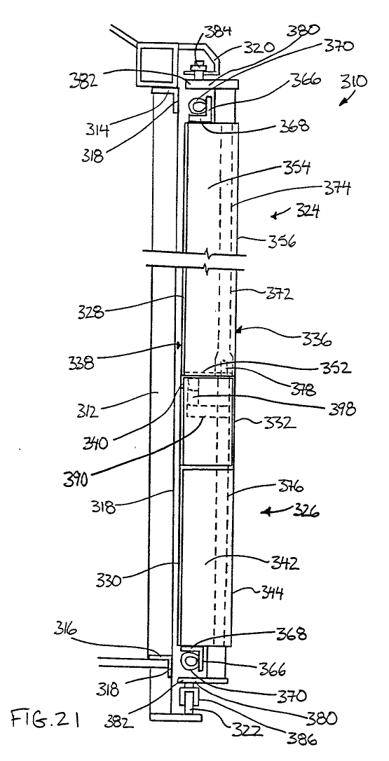

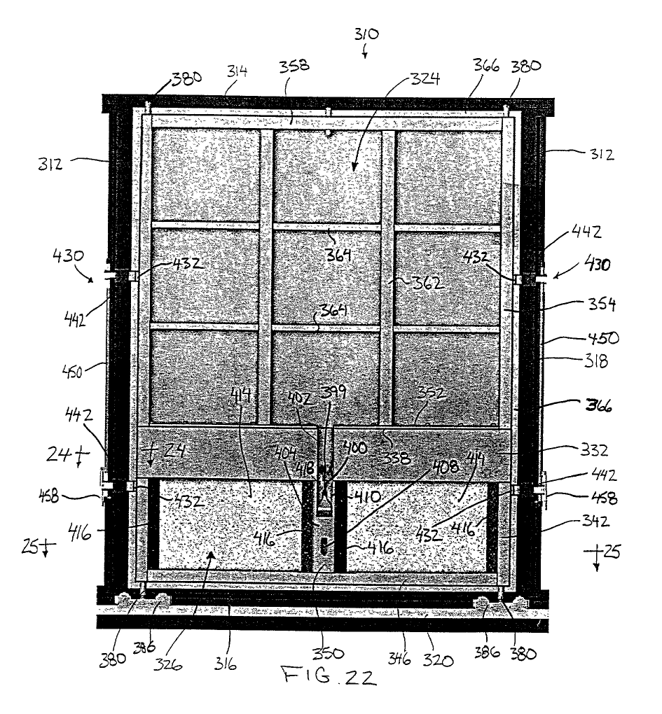

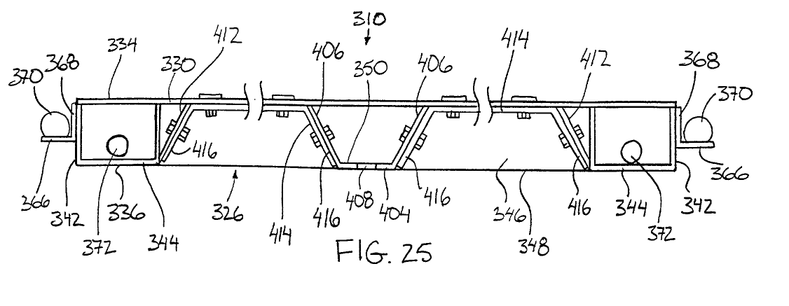

Turning now to FIGS. 19 through 25 there is illustrated a further embodiment of the door construction generally indicated by reference numeral 310. FIGS. 22 through 25 include yet further modifications to the door construction, but the basic door construction 310 in both FIGS. 19 and 22 are similar and shall be described first.

The door 310 is supported on a rail car similarly to the previous embodiment for engagement within an opening in the rail car in a sealing relationship therebetween. As in the previous embodiment the rail car includes a pair of side posts 312 defining the opening in the rail car therebetween. The rail car further includes a top sill 314 and a bottom sill 316 also defining the opening therebetween. The top sill 314 and the bottom sill 316 are arranged such that a forward sealing face 318 thereof lies in a common plane with a forward sealing face 318 of the side posts 312. The door 310 is arranged to span across the opening for sealing engagement with the forward sealing face 318 of the respective posts and top and bottom sill.

Also as described in the previous embodiment, the rail car includes a rail 320 extending longitudinally across the bottom of the opening and a guide 322 which extends in a longitudinal direction across the top of the opening. The door is supported on the rail 320 and guide 322 for longitudinal sliding movement between a closed position at the opening and an open position away from the opening. As described later in further detail a drive mechanism is provided for displacing the door transversely to the rails in the closed position towards the opening from an outer sliding position to an inner sealed position as in the previous embodiments.

The door 310, as in previous embodiments, is formed in two sections including an upper section 324 and a lower section 326. The upper section 324 includes a back sheet 328 which spans the full length of the upper section. The lower section 326 similarly includes a back sheet 330 spanning the width of the lower section.

The lower back sheet 330 is formed into a horizontally extending channel 332 adjacent a top end of the lower section 326. The lower back sheet 330 spans across a rear face 334 of the door adjacent a bottom end and is then bent horizontally spaced just below the top end of the lower section 326 to extend forwardly the width of the door to the forward face 336 of the door and then spans across the forward face 336 of the door up to the top end of the lower section 326 so as to form the channel 332. At the top end of the lower section 326 the sheet 330 then extends rearwardly to the rear face 334 so as to define an end plate 338 for securement to the bottom end of the upper section 324 when the door is assembled. A downturned flange 340 extends downwardly along the rear face 334 of the door from the end plate 338 to provide additional rigidity to the end plate.

A pair of lower side beams 342 are secured to respective sides of the lower section 326. Each lower side beam 342 comprises a C-shaped channel having a base portion 344 lying in a common plane with a forward face 336 of the door and having a pair of side portions extending rearwardly from respective sides of the base portion 344 the width of the door to the rear face 334 where the lower side beams 342 are secured to the back sheet 330. The lower side beams 342 extend vertically between the channel 332 and the bottom of the lower section 326. When secured to the back sheet 330 the lower side beams 342 comprise hollow tube members. A bottom beam 346 extends along the bottom end of the lower section 326 between the lower side beams 342. The bottom beam 346 similarly comprises a C-shaped channel having a base portion 348 which lies in a common plane with a forward face 336 of the door and a pair of side portions extending rearwardly the width of the door from respective sides of the base portion 348 to the rear face 334 where the bottom beam 346 is secured to the back sheet 330. The bottom beam 346 thus forms a tube member when secured to the back sheet 330. One or more vertical stiffener members 350 is arranged to extend between the bottom beam 346 and the channel 332, spaced horizontally between the lower side beams 342. Each vertical stiffener member 350 comprises a channel member having a base portion in alignment with the forward face of the door and a pair of side portions spanning rearwardly to the back sheet 330 of the door.

The upper back sheet 328 may be formed in one or more sections and is arranged to span from a top end to a bottom end of the upper section 324 along the rear face 334 of the door. At the bottom end of the upper section 324 the back sheet is bent horizontally to extend forwardly the width of the door to the forward face 336 thus defining an end plate 352 arranged to be engaged side by side with the end plate 338 of the lower section when the upper and lower sections are secured together. A plurality of fasteners are arranged to secure the end plates in a side by side relationship. The upper section 324 includes a pair of upper side beams 354 which extend vertically along respective sides of the upper section between a top end of the upper section and the end plate 352. Each upper side beam 354 comprises a channel of C-shaped cross section having a base portion 356 in a common plane with a forward face 336 of the door and a pair of side portions extending rearwardly from respective sides of the base portion to the rear face 334 of the door where the respective upper side beams 354 are secured to the upper back sheet 328. The upper side beams 354 thus form respective hollow tube members with the back sheet 328. A top beam 358 extends between the upper side beams 354 along the top end of the upper section 324. The top beam 358 similarly includes a base portion 360 which lies in a common plane with a forward face 336 of the door and a pair of side portions extending rearwardly from respective sides of the base portion to the rear face 334 of the door. A pair of vertical stiffener members 362 span between the top beam 358 and the end plate 352. The vertical stiffener members 362 comprise channel members secured to the back sheet 328 similarly to the upper side beams 354 at horizontally spaced positions between the upper side beams. Horizontal stiffener members 364 extend horizontally between the vertical stiffener members 362 and the upper side beams 354 at vertically spaced positions for additional structural support. The horizontal stiffener members 364 similarly comprise C-shaped channels extending between the forward and rear faces of the door.

A sealing flange 366 is secured to each of the top, bottom, upper and lower side beams of the door in a common sealing plane for sealing engagement with the respective forward sealing faces 318 of the top and bottom sills and the side posts of the rail car. The sealing flange 366 defines a vertical sealing surface about a periphery of the door 310 which extends outwardly from the respective beams of the door. The sealing flange 366 is formed integrally at right angles to a respective mounting flange 368 arranged to be secured to the periphery of the door. Upon assembly of the upper and lower sections of the door 310 the sealing flanges 366 may then be secured to the periphery of the door. The sealing flange and respective mounting flange is formed in continuous sections on each of the top, bottom and sides of the door. The flanges are secured to the door by welding the mounting flange 368 to the respective beam of the door with the sealing flanges 366 on all sides of the door lying in a common sealing plane at any one of various intermediate positions between the forward and rearward face of the door. As the sealing flange 366 is mounted on the door after assembly of the door the particular position of the sealing plane of the sealing flanges 366 can be adjusted to suit a particular application of the door while the mounting flange 366 extending along each side of the door provides additional structural support for securing the upper and lower sections together. A compressible sealing member 370 is secured to an inner side of the sealing flanges 366 about the periphery of door for sealing engagement with the forward sealing faces 318 of the respective top and bottom sills and side posts of the rail car in the inner sealed position of the door.

Sealing force is provided using a similar cam and shaft drive arrangement as described in the previous embodiments. A shaft 372 is mounted within each of the side beams of the door for rotation about a respective upright axis at a location spaced between the respective forward and rear faces of the door. Each shaft 372 is formed into an upper section 374 and a lower section 376 which are received within the respective upper side beams 354 and lower side beams 342 of the respective upper and lower sections of the door. As similarly described in the previous embodiment the upper and lower sections of each shaft are supported on the door by bearings. In the embodiments of FIGS. 19 through 25 additional bearings are provided where the lower section 376 of the shafts passes through respective apertures in the channel 332 extending horizontally across the lower section of the door. The upper and lower sections of the shaft are coupled by respective co-operating lug and socket connections 378 such that the upper and lower sections of the respective shafts are coupled for rotation together. An offset cam member 380 is provided at each of the upper and lower ends of the respective shafts for pulling the door inward from the outer sliding position to the inner sealed position as the shafts 372 are rotated. The outer free ends 382 of the respective offset cam members are arranged to rotate approximately 90° about the respective axes of the shaft from the outer sliding position in which the cam members project inwardly from the respective shafts towards the opening of the rail car and the inner sealed position in which the cam members 380 extend laterally inwardly towards the opposing side of the door.

Also as described in the previous embodiment the free end of the cam members 380 at the top end of the door include respective rollers 384 which are arranged for longitudinal sliding movement within the guide 322 extending across the top end of the opening in the rail car spaced thereabove. The free ends of the cam members 380 at the bottom end of the door 310 are supported on the rail 320 by respective roller carriages 386. The roller carriages 386 are identical in configuration to the roller carriages 166 as described in FIGS. 15 through 18 previously. An operating linkage is provided coupled between the shafts 372 adjacent a top end of the lower sections 326 of the door so as to be received within the horizontally extending channel 332 formed therein. The operating linkage is arranged to effect simultaneous rotation of the shafts 372 upon actuation thereof for displacing the door towards the inner sealed position. A pair of crank arms 390 are mounted on the respective lower sections 376 of the respective shafts adjacent the top end of the lower section 326 within the channel 332. The crank arms 390 are fixed to the respective shafts substantially in alignment with the respective offset cam members 380 for rotation therewith as the shaft is rotated. Rotating the crank arms 390 inwardly towards each other thus forces the cams 380 similarly inwardly towards each other for displacing the door into the inner sealed position. The operating linkage generally comprises a screw mechanism which is coupled between the crank arms 390 of the respective shafts. The screw mechanism includes a collar 390 which is supported centrally within the channel 332 for rotation about a screw access extending in the longitudinal direction of the collar between the respective shafts 372. The collar 392 is internally threaded in opposite directions at respective ends thereof for receiving the ends of a respective pair of threaded rods 394 therein. The pair of threaded rods 394 are threaded in opposite directions and are received within opposite ends of the collar 392 so as to be supported for rotation about the screw axis whereby rotation of the collar 392 acts to either contract or expand the threaded rods towards or away from each other in the longitudinal direction of the rods along the screw axis. A pair of levers 396 are coupled to respective ends of the threaded rods 394 for increasing the amount of throw of the threaded rods for each rotation of the collar 392. The levers 396 are each pivotally mounted at a first end within the channel 332 and is arranged to pivotally mount the respective outer ends of the threaded rods 394 at an intermediate position between respective ends thereof. The free end of each lever 396 opposite the pivoted end secured to the channel 332 pivotally mounts a respective connector arm 398. The pair of connector arms 398 are coupled between the free ends of the respective levers 396 and the free ends of the respective crank arms 390. In this arrangement rotation of the collar 392 in a first direction acts to pull the threaded rods 394 inwardly towards one another thus pulling the connector arms 398 through the respective levers 396 also inwardly towards one another such that the respective crank arms and the shafts 372 coupled thereto rotate the cam members 380 into the inner sealed position. Rotation of the collar 392 in an opposite direction accomplishes the reverse for pushing the crank arms 390 outwardly away from each other to position the door in the outer sliding position. A ratchet mechanism 399 couples a handle 400 to the collar 392 for selectively engaging the handle 400 with the collar 392 to effect rotation of the collar 392 in either direction as desired by reciprocation of the handle 400. A cover sheet, not shown is secured across the rear face 334 of the door at the channel 332 for enclosing the operating linkage within the channel. A portion of the channel 332 at the forward face of the door is cut away to permit access to the handle 400 to rotate the collar 392 enclosed within the channel 332. A vertical channel 402 receives the handle 400 therein when the handle is positioned to lie flat between the forward and rearward faces of the door and is arranged to enclose the cutaway portion of the channel 332. The channel 402 includes appropriate bushings therein for receiving the collar 392 therethrough while rotatably supporting the collar 392 thereon.

The shafts 372 are positioned adjacent the forward face 336 of the door between the forward and rearward faces for minimizing the required throw of the cam members 380. The use of a sealing flange 366 which may be supported at various intermediate positions between the forward and rearward faces enables the use of a common set of cam members 380 regardless of the application of the door to different rail cars having different rail and guide configurations at different spacings from the opening defined between the side posts of the rail car. The door construction 310 is thus particularly well suited as a replacement door onto existing rail cars as a single kit of parts is thus able to be adapted to various rail car opening configurations.

Now turning to FIGS. 22 through 25 some additional features of the door construction 310 are illustrated in further detail. The lower section 326 of the door as illustrated in FIG. 22 includes a single vertical stiffener member 350 located centrally between the lower side beams 342. The vertical stiffener member 350 is a channel member having a base portion 404 which lies in a common plane with the forward face 336 of the door and includes a pair of side portions 406 which extend rearwardly to the back sheet 330 at an incline outwardly from each other from a forward edge in alignment with the forward face of the door to a rearward edge in alignment with the rear face of the door. A hand grip 408 is formed in the base portion 404 in the form of an elongate slot suitable for gripping by a persons hand. A channel 410 is further provided in alignment with the vertical channel 402 which receives the handle 400 therein. The channel 410 is similarly arranged for receiving the handle 400 therein when the handle is positioned to lie flat between the forward and rearward faces of the door and extending downwardly from the collar 392.

Each of the lower side beams 342 of the door as illustrated in FIG. 22 includes at least one mounting tab 412 thereon. The mounting tab extends rearwardly from a forward edge secured to the respective lower side beam adjacent the forward face of the door at a rearward incline inwardly towards the opposing side beam to a rear edge adjacent the rear face 334 of the door. The mounting tabs 412 extend at a similar angle to the side portions 406 of the central vertical stiffener member 350. The lower section 326 is thus arranged to mount a pair of armour plates 414 therein. Each armour plate 414 is a rigid sheet of material which is textured for added strength, being thicker and stronger than the back sheet 330. Each armour plate 414 is arranged to span between the central vertical stiffener member 350 and a respective one of the lower side beams 342. The armour plates span vertically between the lower beam and the horizontal channel 332. The plates 414 are arranged to lie adjacent to the back sheet 330 with respective sides 416 thereof being inclined forwardly and outwardly so as to lie adjacent to either the mounting tabs 412 or the side portions of the central vertical stiffener member 350. The armour plates 414 are secured at respective sides 416 thereof to the mounting tabs 412 and the side portion of the vertical stiffener member 350 using suitable fasteners which permit selective removal of the plates from the lower section of the door for removal and replacement thereof when damaged. Each armour plate 414, having its sides 416 extending forwardly from the back sheet to the forward face of the door at an outward incline, is thus arranged to be substantially dish-shaped for deflecting any impacts from the forks of a forklift along the sides 416 of the respective plates to the strong and durable main portion of the armour plates adjacent the back sheet 330 of the door. Should any damage to the plates result the plates are easily replaced by removing and replacing the fasteners which secure the plates to the mounting tabs and the central vertical stiffener member 350 as well as any fasteners which may additionally be provided to secure the plates to the back sheet 330.

The door construction 310 as illustrated in FIG. 22 further includes a locking member 418 which is pivotally mounted within the channel 410 for selective engagement with the handle 400 of the operating linkage. By pivoting the locking member 418 to overlap the handle 400 a suitable lock may be coupled therebetween to secure to the handle 400 in a locked position lying flat within the vertical channel 410 between the forward and rearward faces of the door.

Also illustrated in FIGS. 22 through 25 there is provided a latching mechanism on each side of the door 310 which is generally indicated by reference numeral 430. The latching mechanism 430 is arranged to secure the sides of the door 310 to the respective side post 312 of the rail car in the inner sealed position of the door.

The latching mechanism includes a pair of brackets 432 which are mounted at vertically spaced positions on each side of the door 310. One of the brackets 432 is thus mounted on each of the upper side beams 354 and lower side beams 342. Each of the brackets 432 is secured to the outer side portion of the respective side beam by a forward mounting portion 434 which lies flat adjacent the side of the beam adjacent the forward face 336 thereof. The brackets 432 are thus positioned forwardly of the sealing flange 366. Each bracket 432 further includes an out turned portion 436 extending from the mounting portion 434 laterally outward along a front side of the sealing flange 366 to a bent outer portion 438 which extends rearwardly from the free end of the sealing flange 366. The bent outer portion 438 includes a free end which is substantially in alignment with the rear face 334 of the door and includes a latching aperture 440 therein adjacent the free end of the bent outer portion and being spaced rearwardly from the sealing flange 366. A pair of the latching apertures 440 are thus located at spaced positions on each side of the door 310 for securement to the respective side posts 312 of the rail car.

A pair of latching sections 442 are provided in each side post 312 of the rail car in alignment with the respective brackets 432 on the door. Each latching section 442 replaces a section of the existing side post 312 so as to be configured for receiving the respective bent outer portion 438 of the brackets therein when the door is displaced into the inner sealed position with the sealing flange 366 adjacent the forward sealing face 318 of the posts. Each latching section 442 is substantially identical in cross section to the respective side posts 312 and includes a latching slot 444 in alignment with the respective bent outer portion 438 of the respective bracket for receiving the bent outer portion therein in the inner sealed position of the door. Each latching section 442 further includes a sliding latch member 446 which is supported within the latching section by a channel 448 for lateral sliding movement transversely to the bent outer portion 438 of the respective bracket. Each sliding latch member 446 is in alignment with a respective one of the latching apertures 440 for sliding movement when the door is in the inner sealed position between a latched position in which the sliding latch member is received through the respective latching aperture so as to restrict removal of the bracket from the corresponding latching section and a released position in which the sliding latch member 446 is slidably displaced in relation to the latched position so as to be released from the respective latching aperture 440 such that the bracket 432 is free to be released from the respective latching section 442 of the side posts 312. In this arrangement the door 310 may be selectively latched when positioned in the inner sealed position.

The sliding latch members 446 are actuated between the respective latched and released positions by a shaft 450 mounted on each of the side posts 312 of the rail car. Each shaft 450 is thus arranged to be coupled to a respective pair of the sliding latch members 446 for actuation thereof. The shafts 450 are supported for rotation about respective upright longitudinal axes, being coupled adjacent respective ends thereof to the respective sliding latch member 446 which are supported at vertically spaced positions on the respective side posts 312. A pair of crank arms 452 couple each sliding latch member 446 to the respective shaft 450. Each pair of crank arms 452 are coupled to the respective shaft 450 for rotation therewith and extend radially outward from the shaft to respective free ends which are arranged to be pivotally coupled to the respective sliding latch member 446 on opposing sides thereof. The crank arms 452 are coupled to the respective sliding latch member by a pin 454 extending between the crank arms which is received through a mounting slot 456 in the respective sliding latch member 446. The mounting slot 456 extends transversely to the sliding direction of the sliding latch member so as to accommodate the varying location of the pin 454 in relation to the sliding latch member as the respective shaft 450 is rotated.

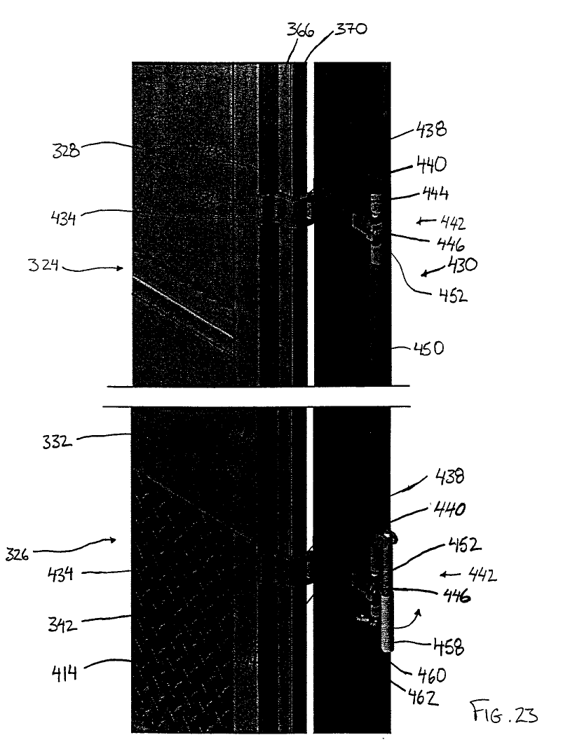

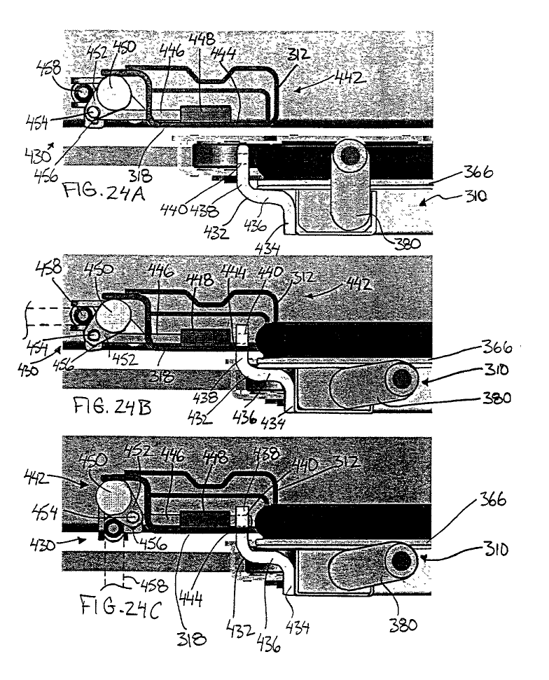

A handle 458 is mounted on each of the shafts 450 for manually effecting rotation of the shaft. Each handle 458 is pivotally mounted at an inner end on the respective shaft 450 for movement between a useable position in which the handle 458 extends radially outward from the shaft and a stored position in which the handle 458 lies parallel along side the shaft 450. The door 310 is shown displaced between the outer sliding position and a latched inner sealed position in FIGS. 24A through 24C. In order to latch the door the door is first positioned in the outer sliding position with the shafts 450 being pivoted such that the sliding latch members 446 are located in the respective released positions. Actuation of the cam members 380 pull the door inwardly towards the inner sealed position whereby the outer bent portions 438 of the respective brackets 432 are received within the respective latching slots 444 of the respective latching sections 442 of the side posts. The handle 458 on each of the shafts may thus be pivoted into the useable position for rotating the shafts 450 independently of one another into the latched position. Displacing the shafts 450 into the latched position causes the sliding latch members 446 to be slidably engaged into the respective latching apertures 440 of the respective brackets 432 to restrict displacement of the door into the outer sliding position. As the shafts 450 are rotated the pin 454 extending between each pair of crank arms 452 is slidably displaced within the respective mounting slot 456 while the sliding latch member is slidably displaced within the respective channel 448 following the lateral displacement of the free ends of the crank arms.

The latching mechanism 430 is particularly well suited for mounting onto either the door 310 as illustrated or any existing door on an existing rail car as desired. When retrofitting an existing rail car with the latching mechanism 430, the latching sections 442 replace existing sections of the side posts 312 of the rail car. The brackets 432 may then be secured to respective sides of the door by welding the brackets at any one of numerous positions for alignment with the respective latching slots 444 in the respective latching sections of the posts. Each shaft 450 further includes a lug 460 thereon having an aperture therein for alignment with a corresponding lug 462 secured to the respective side post 312 in the latched position of the latching mechanism. Alignment of the lugs 460 and 462 in the latched position permits a locking member to be secured therebetween such that displacement of the latching mechanism into the released position is restricted by unauthorized persons.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a sliding door member mounted on top and bottom rails at the opening extending parallel to a plane of the opening with the door movable from a closed position at the opening to an open position spaced along the rails from the opening;
the sliding door member including side beams, a top beam and a bottom beam which co-operate respectively with the side posts, top beam and bottom sill respectively in a sealing action;
each of the side beams, top beam and bottom beam of the sliding door including a sealing surface parallel to the sealing plane for sealing with the respective sealing surface by a compressible sealing member therebetween;
the sliding door member including an interior sheet extending to the beams and lying in a vertical plane;
each of the beams including a front wall parallel to the interior sheet, an outer side wall joining the front wall and the interior sheet and an inner side wall joining the front wall and the interior sheet;
pivotal mounting members mounting the door member on the rails for movement of the door in a direction transverse to the rails so as to move the door in the closed position inwardly toward the opening from an outer sliding position to an inner sealed position to effect sealed closure within the opening; and
an actuation system for effecting actuation of the pivotal mounting members comprising a pair of vertical shafts each having a respective one of the pivotal mounting members at its upper end and at its lower end, each of the shafts being contained within a respective one of the side beams mounted therein for rotation about its axis.

2. The sliding door according to claim 1 wherein the actuation system includes an operating linkage connected between the shafts and operable to effect simultaneous rotation of the shafts.

3. The sliding door according to claim 2 wherein there is provided a channel extending horizontally between the respective side beams spaced between the top beam and the bottom beam, the operating linkage being received within the channel.

4. The sliding door according to claim 2 wherein the operating linkage comprises a crank arm extending radially outward from each shaft and a screw mechanism coupled to extend in a longitudinal direction between the crank arms of the respective shafts, the screw mechanism being supported for rotation about a screw axis extending in the longitudinal direction and being arranged to expand and contract in the longitudinal direction in response to rotation of the screw mechanism about the screw axis whereby the pair of vertical shafts are rotated simultaneously as the crank arms are displaced towards and away from each other.

5. The sliding door according to claim 4 wherein the actuation system includes a manually operable handle arranged for driving rotation of the screw mechanism and a ratchet mechanism arranged to selectively engage the handle with the screw mechanism.

6. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a sliding door member mounted on top and bottom rails at the opening extending parallel to a plane of the opening with the door movable from a closed position at the opening to an open position spaced along the rails from the opening;
pivotal mounting members mounting the door member on the rails for movement of the door in a direction transverse to the rails so as to move the door in the closed position inwardly toward the opening from an outer sliding position to an inner sealed position to effect sealed closure within the opening;
an actuation system for effecting actuation of the pivotal mounting members;
the sliding door member including side beams, a top beam and a bottom beam which cooperate respectively with the side posts, top beam and bottom sill respectively in a sealing action;
the sliding door member including an interior sheet extending to the beams and lying in a vertical plane;
wherein the door member is formed in two separate pieces connected together, each piece including one beam and part of two of the beams at right angles to that beam together with a part of the interior sheet.

7. The sliding door according to claim 6 wherein each piece includes a flat plate as an end plate at its end opposite to the beam such that the pieces are connected together by the end plates lying in side by side butting relation and fastened together.

8. The sliding door according to claim 6 wherein the pieces are divided horizontally into an upper piece and a lower piece with one piece being larger than the other and being dimensioned so as to have a length from the beam to an end opposite the beam of the order of eight feet.

9. The sliding door according to claim 8 wherein the lower piece includes at least one additional reinforcement sheet lying parallel to the interior sheet, the reinforcement sheet being selectively separable from the lower piece for replacement thereof.

10. The sliding door according to claim 6 wherein the pieces are divided horizontally into an upper piece and a lower piece and the actuation system comprises a pair of vertical shafts each having a respective one of the pivotal mounting members at its upper end and at its lower end, each of the shafts being contained within a respective one of the side beams mounted therein for rotation about its axis and wherein the shafts are each formed in two sections with one section in each piece and a coupling for connection between the sections when the pieces are connected together, the coupling being arranged to provide drive connection between the parts.

11. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a sliding door member mounted on top and bottom rails at the opening extending parallel to a plane of the opening with the door movable from a closed position at the opening to an open position spaced along the rails from the opening;
pivotal mounting members mounting the door member on the rails for movement of the door in a direction transverse to the rails so as to move the door in the closed position inwardly toward the opening from an outer sliding position to an inner sealed position to effect sealed closure within the opening;
an actuation system for effecting actuation of the pivotal mounting members;
the sliding door member including side beams, a top beam and a bottom beam which cooperate respectively with the side posts, top beam and bottom sill respectively in a sealing action;
the sliding door member including an interior sheet extending to the beams and lying in a vertical plane;
and air inlet openings in the door member arranged to cause air to be forced therethrough by travelling movement of the rail car and to direct the air into the rail car.

12. The sliding door according to claim 11 wherein the air inlet openings include openings in the interior sheet.

13. The sliding door according to claim 12 wherein at least one of the side beams and either the top beam or the bottom beam are hollow and interconnected and wherein there is provided air inlet openings in said at least one of the side beams to allow passage of air therethrough from the side beam to the top or bottom beam and through the openings in the interior sheet in alignment with either the hollow top beam or hollow bottom beam.

14. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a bottom rail;
a sliding door member mounted on the bottom rail at the opening extending parallel to a plane of the opening with the door movable from a closed position at the opening to an open position spaced along the rails from the opening;
pivotal mounting members mounting the door member on the bottom rail for movement of the door in a direction transverse to the rails so as to move the door in the closed position inwardly toward the opening from an outer sliding position to an inner sealed position to effect sealed closure within the opening;
an actuation system for effecting actuation of the pivotal mounting members;
each pivotal mounting member including a roller carriage for rolling movement along the rail, the roller carriage having a housing with side plates and a pair of rollers mounted in the housing between the side plates with one roller in front of the other and aligned for sitting on a top surface of the rail, the housing defining a slot between the side plates through which the top surface of the rail passes such that the rail is cleaned of debris by the slot as the carriage moves along the slot, the housing having on an inside surface of each of the side plates a low friction wear-resistant plastics liner material for running along a respective side surface of the rail.

15. The sliding door according to claim 14 wherein the housing has a front wall and a rear wall with the side plates extending downwardly below a bottom edge of each of the front and rear walls defining the slot, the front and rear walls being supported on the housing for upward and downward movement in relation to the housing for alignment with the top surface of the rail.

16. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a sliding door member mounted on top and bottom rails at the opening extending parallel to a plane of the opening with the door movable from a closed position at the opening to an open position spaced along the rails from the opening;
pivotal mounting members mounting the door member on the rails for movement of the door in a direction transverse to the rails so as to move the door in the closed position inwardly toward the opening from an outer sliding position to an inner sealed position to effect sealed closure within the opening;
an actuation system for effecting actuation of the pivotal mounting members;
the sliding door member including two side beams, a top beam and a bottom beam which co-operate respectively with the side posts, top beam and bottom sill respectively in a sealing action;
each of the side beams, top beam and bottom beam of the sliding door including a sealing flange extending outwardly from the beam defining a sealing surface parallel to the sealing plane for sealing with the respective sealing surface by a compressible sealing member therebetween;
the sliding door member including an interior sheet extending to the beams and lying in a vertical plane; and
each of the beams having a front wall parallel to the interior sheet and an outer side wall joining the front wall and the interior sheet.

17. The sliding door according to claim 16 wherein each sealing flange is mounted at right angles to a mounting flange, the mounting flange being adjustably supported on the outer side wall of the respective beam such that the sealing flange lies between the front wall and the interior sheet.

18. A sliding door for a rail car construction comprising a floor, a side wall along one side of the floor and standing upwardly from the floor, an opening in the side wall defined by two side posts each at a respective side of the opening, a top beam extending across a top of the opening and a bottom sill defining an edge of the floor at the opening, the side posts, the top beam and the bottom sill including a sealing surface lying in a common vertical sealing plane;
the sliding door comprising:
a sliding door member mounted on top and bottom rails at the opening extending parallel to a plane of the opening with the door movable from a closed position at the opening to an open position spaced along the rails from the opening;
pivotal mounting members mounting the door member on the rails for movement of the door in a direction transverse to the rails so as to move the door in the closed position inwardly toward the opening from an outer sliding position to an inner sealed position to effect sealed closure within the opening;
an actuation system for effecting actuation of the pivotal mounting members; and
a latching mechanism supported on each of the side posts including at least one slide member mounted for sliding movement between a latched position in which said at least one slide member is received within a respective latching aperture in the sliding door member with the sliding door member in the inner sealed position and a released position in which said at least one slide member is disengaged from the sliding door member.

19. The sliding door according to claim 18 wherein each latching aperture is located in latching flange secured to respective one of the side beams of the sliding door member.

20. The sliding door according to claim 19 wherein each latching flange is arranged to be received within a respective slot in the side post in the inner sealed position of the door and wherein the respective slide member extends through the respective side post in the latched position.
